(19) United States
(12) Patent Application Publication
(10) Pub. No.: US 2007/0255761 A1
(43) Pub. Date: Nov. 1, 2007

(54) Tools to facilitate document information access

(75) Inventor: Dale E. Gaucas, Rochester, NY (US)

Correspondence Address: Miele Law Group PC, 36 Lovering Street, Medway, MA, 02053, US

(73) Assignee: Xerox Corporation

(21) Appl. No.: 11/412,640

(22) Filed: Apr. 27, 2006

(51) Int. Cl. G06F 17/30

(52) U.S. Cl. 707/201

(57) ABSTRACT

Apparatus are provided including an information repository and an expiration mechanism. The information repository holds current document state information, and the expiration mechanism expires state information for certain documents in accordance with an expiration scheme.

### FIELD OF THE DISCLOSURE

Aspects of the present disclosure relate to tools to facilitate document information access.

### BACKGROUND

Various systems exist that facilitate online access to documents and to information concerning those documents, for example, version information. For example, the Digital Object Identifier System® is a system for identifying content objects in a digital environment. Digital Object Identifiers (DOIs) are names assigned to an entity for use on the digital network. They are used to provide current information, including where the object can be obtained on the Internet. The Corporation for National Research Initiatives describes a Handle System®, which is a system for assigning, managing, and resolving persistent identifiers which they refer to as “handles” for digital objects and other resources on the Internet. The Online Computer Library Center (OCLC) provides software for implementing Persistent Uniform Resource Locators (PURLs). A PURL is like a URL. Instead of pointing directly to the location of an Internet resource, a PURL points to an intermediate resolution service. The PURL resolution service associates the PURL with an actual URL, and returns that URL to the requester.

There is a need for further features that facilitate online document information access and as well as access to updated versions of documents.

### SUMMARY

In accordance with one embodiment of the disclosure, apparatus are provided. An information repository is provided which holds current document state information. The information repository includes an expiration mechanism to expire state information for documents.

### BRIEF DESCRIPTION OF THE DRAWINGS

Embodiments of the disclosure are further described in the detailed description which follows, by reference to the noted drawings, in which like reference numerals represents similar parts throughout the several views of the drawings, and wherein:

FIG. 1 is a block diagram of a network system, which includes a document distribution system in accordance with one embodiment of the disclosure;

FIG. 2 is a schematic diagram of one or more document requester screens;

FIG. 3 is a schematic diagram of a document file and/or a document, including document information list (DIL) information; and

FIG. 4 shows a flow chart of a portion of a process performed by a document processing mechanism, such as a word processor.

### DETAILED DESCRIPTION

Aspects of the disclosure are directed to tools that facilitate, via online systems, access to documents and to document information. Various features are described herein which allow for the ready online access to document information updates. In addition, features are disclosed which allow for the ready online access to the latest version information concerning documents, as well as ready online access to the latest version of the document itself. All this information is accessible, for example, by reference to information provided in a document to which the document requester is provided access. That document may be an outdated document. In embodiments described herein, the outdated document includes document information list information that can be used to facilitate access to document information as described above. This document information list information may be embedded in the overhead portion of the digital file of the document, or embedded into the content of the document itself.

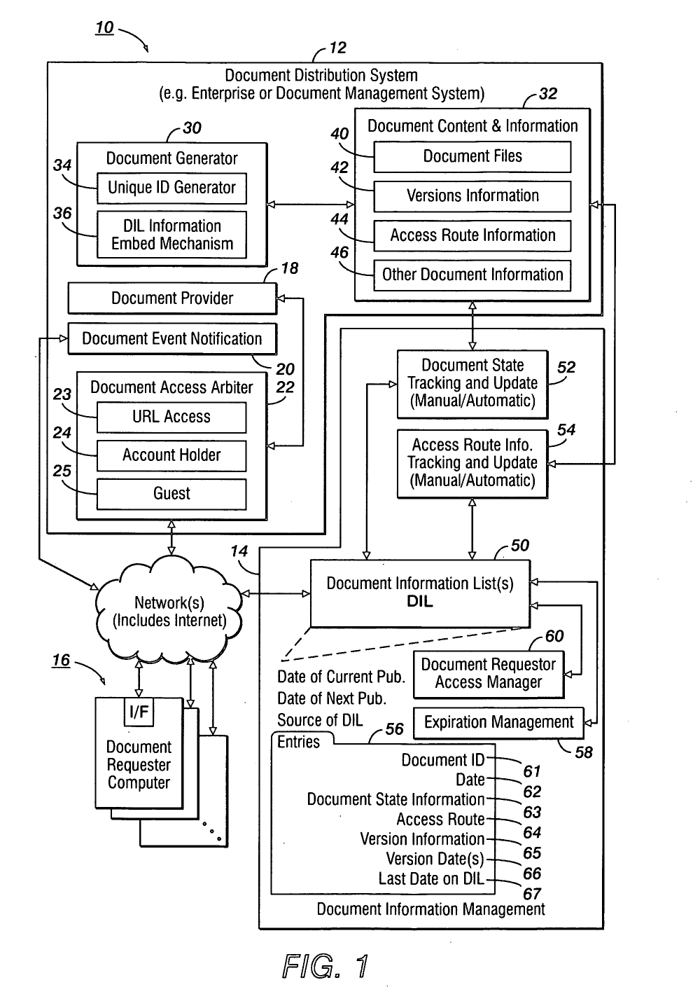

Referring now to the drawings in greater detail, FIG. 1 shows a networked system 10. The illustrated networked system 10 includes a document distribution system 12, a document information management system 14, and plural document requester computers 16 coupled to document distribution system 12 and document information management system 14 via one or more networks, which networks include, in the illustrated embodiment, the Internet.

The document distribution system 12 may, for example, be an enterprise system or a document management system. The illustrated document distribution system 12 includes a document provider 18 to provide document requesters with requested documents, and a document event notification mechanism 20 to notify document requesters of certain events concerning a document, for example, a version change. A document access arbiter 22 is also provided. The document access arbiter 22 controls access to requested documents and to the document distribution system 12 more generally. Access may be provided for a given document requester via a URL access 23. Access may be restricted to only certain document requesters. The restriction of access may be handled by secure connections which may be required to access document distribution system 12. Access to the document access arbiter 22 via a secure connection may be managed to limit such access to only account holders via an account holder mechanism 24 and guests via a guest mechanism 25.

Document distribution system 12 may include a document generator and/or modifier 30, which either generates or modifies documents. By way of example, document generator and/or modifier 30 may include a document creation and editing application, for example, a presentation application, a word processing application, or an image file application. In addition, or in the alternative, by way of example, document generator or modifier 30 may include a mechanism for modifying either the document content itself or the overhead portion of the document file to include certain information, including a unique document identifier as well as document information list information. For this purpose, document generator or modifier 30 may be provided with a unique identification generator 34 and with a document information list (DIL) information embedding mechanism 36.

In the process of document generator or modifier 30 generating or modifying a document, document content and information 32 is created and stored. The illustrated schematic representation of the stored document content and information 32 includes document files 40, version information 42, access route information 44, and other document information 46.

The document information management system 14 manages information concerning documents as well as access to such information by document requesters via their document requester computers 16. The document information management system 14 may include an information repository holding current document state information, and including an expiration mechanism to expire state information for certain documents. In the specific embodiment illustrated in FIG. 1, the information repository includes one or a plurality of document information list (DILs) 50. A given DIL 50 includes information including a date of current publication of the DIL, the date of the next expected publication of the DIL, a set of entries for respective documents, and the source of the DIL (e.g., the corporation that has published the DIL or the computer system on which the DIL is held).

For each document for which information is included in the DILs 50, a document information entry 56 is included. The document entry 56, as illustrated in the exampled embodiment, may include records including unique document identifier 61, the date of the document 62, the document state information 63 (e.g., document currently open by another user; document in final; final version; etc.), and the access route 64 for the document. The access route 64 for the document may, for example, be identified in the record as a URL. The illustrated document information entry 56 further includes records including version information 65, one or more version dates 66 corresponding to the version information, and the last date on DIL 67. The last date on DIL 67 is the date after which the document information in DILs 50 will be expired and will either be deleted from the DIL or no longer accessible by a document requester.

An expiration management mechanism 58 may be provided to stop access to an entry for an individual document when the entry for the individual document includes a last date on DIL that has been reached. The expiration management mechanism 58 may be further provided with a mechanism to delete the entry from the DIL for that individual document.

The illustrated document information management system 14 may be further provided with a document requester access manager 60 to manage the access that will be allowed for particular document requesters via their computers 16. For example, only certain document requesters having a particular digital signature or certain document requesters that can provide certain login information may be provided access to the DIL(s) 50.

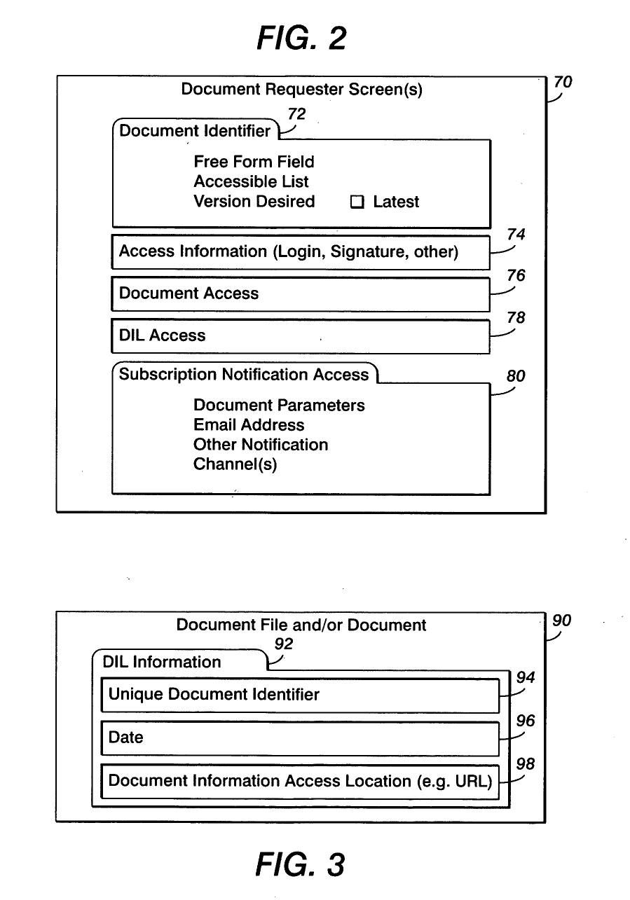

A given document requester computer 16 includes an interface for interfacing with document distribution system 12 and/or document information management system 14. The interface may include, for example, a web browser, an application uniquely designed for access to those systems, or another type of interface. The interface may present, to the document requester, one or more document requester screens 70 as schematically shown in FIG. 2. A schematic representation shown in FIG. 2 includes blocks representing the functions of various graphical tools presented to a document requester via one or more document requester screens. Those graphical tools include a document identifier tool 72, access information tool 74, a document access tool 76, a DIL access tool 78, and subscription notification access tool 80. Document identifier tool 72 may include a graphical tool which allows the document requester to indicate the unique document identifier for which information is sought by the document requester. The document identifier graphical tool may be in the form of a free form field, an accessible list presenting to the document requester a list of available documents or available document information, and other fields or buttons allowing the document requester to indicate specific information about that document, such as, for example, the fact that the latest version of the document may be desired by the document requester.

The access information tool 74 may include a graphical tool for facilitating access to the document or to information, either via document distribution system 12, or via document information management system 14. That access information tool 74 may facilitate the input of login information by the document requester, or it may process additional signature information forwarded from the document requester computer 16 in connection with a particular request, or other interactions with the document requester computer or input by the document requester via the screen.

Document access tool 76 may include a graphical tool for allowing the document requester via a computer screen to specify information required to access the document itself. The document access tool 76 may include a search function which includes a field choice term input for searching for documents meeting certain criteria specified in that field choice term input. In addition, for example, document access tool 76 may allow the user to specify a URL which will take the document requester via the computer screen directly to the document via an HTTP redirect.

DIL access tool 78 may include a graphical tool to facilitate the document requester's interaction through one or more computer screens to cause secure or public (e.g., via a URL) access to document information within document information management system 14, particularly, in one or more document information lists DILs 50.

Subscription notification access tool 80 may include graphical tools to allow the document requester to input, for example, document parameters, an email address of the document requester, and other notification channels of the requester, through which notification information concerning events of the document can be sent.

FIG. 3 is a schematic diagram of a document file and/or a displayed or printed version of a document 90. The illustrated document file and/or document 90 includes DIL information 92. The DIL information 92 includes a unique document identifier 94, a date of the document 96, and the document information access location 98. The document information access location may, for example, be in the form of a URL. The document information access location may specifically refer to the access route through which the appropriate DIL 50 may be located and accessed by the document requester.

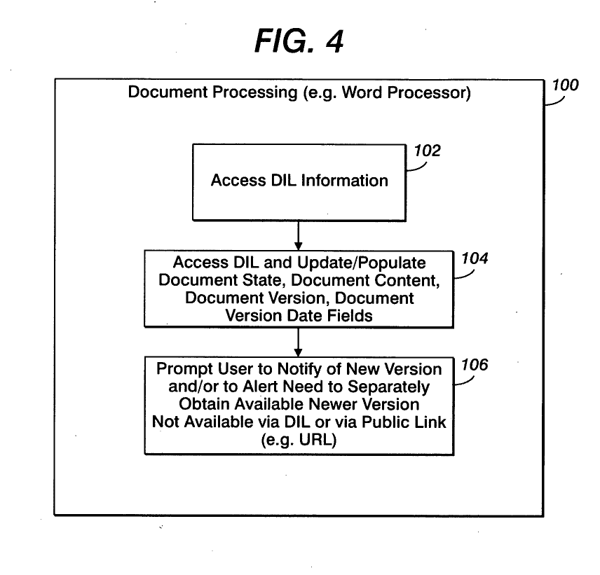

FIG. 4 shows a flow chart of a portion of the process performed by a document processing application 100. The document processing application may include, for example, a word processor. The acts shown in the flow chart in FIG. 4 pertain to document information list acts which may be included within the processing performed by a document processing application. Those acts include accessing DIL information at act 102, which may be embedded within a given document. Upon obtaining the DIL information from a given document, in a next act 104, the process accesses the appropriate DIL, and updates or populates the document state, content, version, and version date fields associated with that document within the document file or within other fields or overhead storage mechanisms used by the document processing application. In a next act 106, the application may prompt the user to notify the user that there is a new version to the document that exists. In addition, or in the alternative, the application may prompt the user to alert the user that there is a need to separately obtain an available newer version of the document that is not available via the DIL or via a public link (e.g., URL).

The illustrated document distribution system 12 may be provided with a firewall, and access thereto may be limited to those entities which have, for example, a private key in accordance with the PKI infrastructure of such a system. One or more portions of document information management system 14 may be provided either inside of the firewall of system 12 or outside of that firewall.

The illustrated DILs 50 may each include software instantiated by or with document distribution system 12. For example, each of the DILs 50 in operation with a given document distribution system 12 may be installed (and/or instantiated) at the time of installation of document distribution system 12 as part of that installation. Alternatively, each DIL 50 may be installed (and/or instantiated) subsequent to the installation of document distribution system 12 or a portion thereof, upon the selection of an option within document distribution system 12 software to provide for one or more DILs 50, or to provide for an additional DIL 50.

In accordance with one or more embodiments described above, a document information management system may be provided which allows for temporary document identification and location information. While the information provided within the document information list or lists can be permanent, the illustrated embodiments include expiration features including last date on DIL record as well as an expiration management mechanism. The expiration can be managed in order to increase security and reduce the risk that unauthorized persons will be able to obtain access to certain documents. Another benefit of the features and architecture described in the various embodiments includes the ease with which the system can be implemented.

The claims as originally presented, and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. Apparatus comprising:
an information repository holding current document state information, the information repository including an expiration mechanism to expire state information for documents within the current document state information.

2. The apparatus according to claim 1, further comprising a document distribution system.

3. The apparatus according to claim 1, further comprising a document production mechanism to produce a document, the document production mechanism including a unique identification generator to generate a unique identifier for each document and an embed mechanism to embed document information list information into documents.

4. The apparatus according to claim 3, wherein the document production mechanism includes a mechanism to generate or modify a document.

5. The apparatus according to claim 3, wherein the document production mechanism includes at least one of a word processor, a spreadsheet application, an image-based document production application, and a presentation application.

6. The apparatus according to claim 3, wherein the embed mechanism includes a mechanism to add to the content of a document the document information list information.

7. The apparatus according to claim 3, wherein the embed mechanism includes a mechanism to include the document information list information in an overhead portion of a document file.

8. The apparatus according to claim 1, wherein the current document state information includes version information.

9. The apparatus according to claim 1, wherein the current document state information includes latest versions of respective documents.

10. The apparatus according to claim 1, wherein the current document state information includes access routes of respective documents.

11. The apparatus according to claim 10, wherein the access routes of respective documents include URLs.

12. The apparatus according to claim 1, wherein the current document state information includes for each document of a plural set of documents an entry, the entry including, for a given document, a list of records including a unique document identifier uniquely identifying the given document, a date of the given document, state information regarding the given document, an access route for the given document, a latest version of the given document, a version date of the latest version, and a last date of document information availability for the given document.

13. The apparatus according to claim 1, wherein the information repository includes one or more document information lists, each of the document information lists being accessible by document requesters via a network connection.

14. The apparatus according to claim 13, wherein the document information lists are accessible by document requesters via an Internet connection.

15. The apparatus according to claim 14, wherein the document information lists are accessible by document requesters via an URL access.

16. The apparatus according to claim 12, further comprising an expiration management mechanism to stop access to an entry for an individual document when the entry for the individual document includes a last date on document information list that has been reached.

17. The apparatus according to claim 1, further comprising a populate and update mechanism to track state changes in document state information and to populate or update information in the information repository in accordance with the state changes.

18. The apparatus according to claim 17, wherein the populate and update mechanism further includes a mechanism to further track access route changes in the access route information and to populate or update the information repository in accordance with the access route changes.

19. A method comprising:
storing information in an information repository, the information including current document state information; and
expiring the state information for documents within the information repository in accordance with a particular expiration scheme.

20. Machine-readable media encoded with data, the encoded data interoperable with a machine to cause:
storing information in an information repository, the information including current document state information; and
expiring the state information for documents within the information repository in accordance with a particular expiration scheme.
